(19) United States
(12) Patent Application Publication
(10) Pub. No.: US 2008/0013758 A1
(43) Pub. Date: Jan. 17, 2008

(54) EXTERNALLY CONNECTED MICROPHONE MODULE

(75) Inventors: Yu-De Tsai, Taipei City (TW); Ming-Ching Lin, Taipei City (TW)

Correspondence Address: THOMAS, KAYDEN, HORSTEMEYER & RISLEY, LLP, 600 GALLERIA PARKWAY, STE 1500, ATLANTA, GA, 30339, US

(73) Assignee: FORTEMEDIA, INC., Cupertino, CA (US)

(21) Appl. No.: 11/608,375

(22) Filed: Dec. 8, 2006

(30) Foreign Application Priority Data
Jul. 17, 2006 (TW) 95126037

(51) Int. Cl. H04R 3/00; H04R 1/02

(52) U.S. Cl. 381/122; 381/91

(57) ABSTRACT

A microphone module is externally connected to an electronic device which includes a first sound input jack. The microphone module includes a microphone array, a digital signal processor, and a first connecting part. The microphone array receives sound and generates a first electrical signal. The digital signal processor receives the first electrical signal, performs beam forming and noise suppression, and obtains a second electrical signal. The first connecting part is inserted into the first sound input jack, transmitting the second electrical signal to the electronic device.

### BACKGROUND OF THE INVENTION

1. Field of the Invention

The invention relates to a high-quality externally connected microphone module.

2. Description of the Related Art

Referring to FIG. 1, an externally connected microphone module 11 stands on a surface via a base 12 thereof. The microphone module 11 contains an omni-directional microphone or a uni-directional microphone to receive sound. In operation, the microphone module 11 is connected to, for example, a notebook computer (not shown) through an audio cable 14 for internet communication or sound recording.

In this case, a single microphone receiving sound is susceptible to unwanted environmental noise, and echo is possible. The quality of received sound can thus often be poor.

### BRIEF SUMMARY OF THE INVENTION

The invention provides a high-quality externally connected microphone module. The microphone module is externally connected to an electronic device which includes a first sound input jack. The microphone module includes a microphone array, a digital signal processor, and a first connecting part. The microphone array receives sound and generates a first electrical signal. The digital signal processor receives the first electrical signal, executes beam forming and noise suppression, and obtains a second electrical signal. The first connecting part is inserted into the first sound input jack, transmitting the second electrical signal to the electronic device.

The microphone module may further include a battery or a universal serial bus connector supplying power to the digital signal processor.

The microphone module may further include a housing, wherein the microphone array and the digital signal processor are disposed in the housing, and the first connecting part is disposed outside the housing.

The electronic device may further include a first sound output jack, and the microphone module further comprise a second connecting part inserted into the first sound output jack, transmitting a third electrical signal from the electronic device to the digital signal processor for performing echo cancellation.

The microphone module may further include a housing, a third connecting part, and a box. The microphone array is disposed in the housing. The third connecting part protrudes from the housing and detachably connects to the box. The digital signal processor is disposed in the box and electronically connected to the electronic device via the first and second parts.

The box may include a second sound input jack and a second sound output jack, and the third connecting part is connected to the second sound input jack.

The microphone array may include a uni-directional microphone and an omni-directional microphone. The microphone module further includes a switch for turning the uni-directional microphone on and off.

The microphone array may include two omni-directional microphones. The microphone module further includes a switch for turning one of the omni-directional microphones on and off.

The microphone array may include two uni-directional microphones.

The electronic device can be a cellular phone, a personal digital assistant, or a global positioning system.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic diagram of an externally connected microphone module;

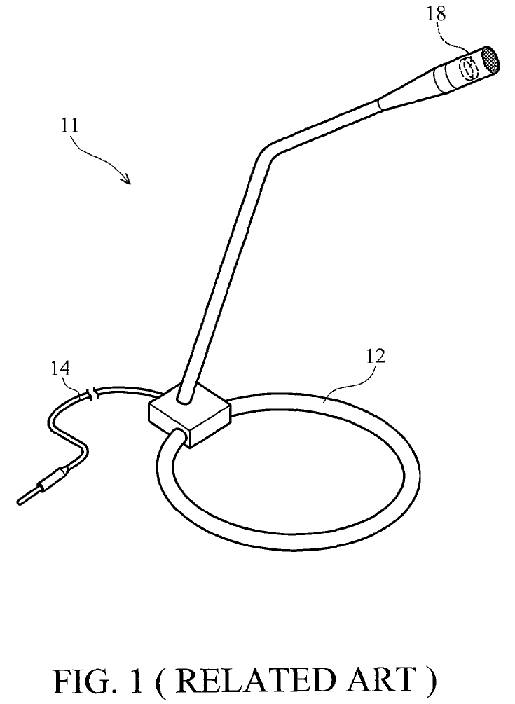

FIG. 2A depicts an externally connected microphone module in accordance with a first embodiment of the invention;

FIG. 2B depicts a microphone module containing a universal serial bus connector rather than a battery of the first embodiment;

FIG. 3 depicts an externally connected microphone module in accordance with a second embodiment of the invention; and

FIG. 4 depicts an externally connected microphone module in accordance with a third embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

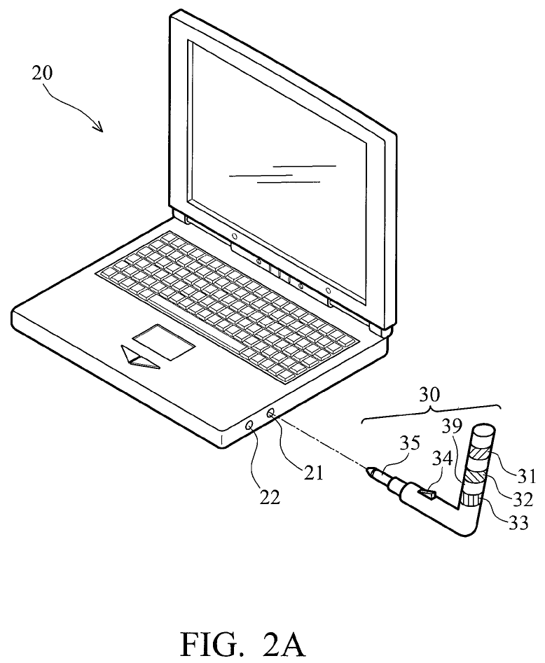

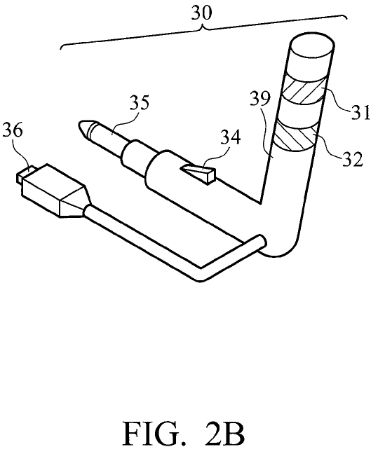

FIG. 2A depicts a microphone module 30 externally connected to a notebook computer 20 in accordance with a first embodiment of the invention. It is understood, however, that the microphone module of the invention can be connected to a cellular phone, a personal digital assistant (PDA), a global positioning system (GPS), or other electronic device.

The microphone module 30 includes a microphone array 31, a digital signal processor (DSP) 32, a battery 33, a switch 34, a first connecting part 35, and a housing 39, described as follows.

The housing 39 is substantially L-shaped. The microphone array 31, the digital signal processor (DSP) 32, and the battery 33 are disposed in the housing 39. The switch 34 is mounted on the housing 39. The first connecting part 35 protrudes from the housing 39.

The microphone array 31 is unidirectional for receiving sound from a predetermined direction and correspondingly generating a first electrical signal. In the first embodiment, an omni-directional microphone and a uni-directional constitute the microphone array 31.

The digital signal processor (DSP) 32 receives the first electrical signal from the microphone array 31, executes beam-forming and noise suppression, and obtains a second electrical signal.

The battery 33 is disposed in the microphone module 30 for supplying power to the digital signal processor (DSP) 32. The battery 33, however, can be replaced with a universal serial bus (USB) connector. As shown in FIG. 2B, the notebook computer 20 or another electronic device (not shown) is electrically connected to the microphone module 30 through a universal serial bus (USB) connector 36 for supplying power to the digital signal processor (DSP) 32.

The notebook computer 20 has a first sound input jack 21 and a first sound output jack 22. The first connecting part 35 of the microphone module 30 is inserted into the first sound input jack 21, transmitting the second electrical signal from the digital signal processor (DSP) 32 to the notebook computer 20 for sound-recording, internet communications or other operation.

As described, the microphone array 31 receives sound from a predetermined direction. However, in some situations (e.g. in a meeting) sound from all directions needs be received. Thus, the uni-directional microphone of the microphone array is turned off by the switch 34 and only the omni-directional microphone of the microphone array operates. Under such a circumstance, the digital signal processor (DSP) 32 merely performs noise suppression. The operation of beam-forming is not required and is thus omitted.

In the first embodiment, the microphone array 31 includes an omni-directional microphone and a unidirectional microphone. The microphone array, however, may include two omni-directional microphones or two uni-directional microphones. When two omni-directional microphones constitute the microphone array and sound from all directions is to be received, one of the omni-directional microphones is turned off by the switch and the other is used to receive sound. When two uni-directional microphones constitute the microphone array, there is no way to receive sound from all directions by turning off any of the uni-directional microphones. Thus, no switch is provided.

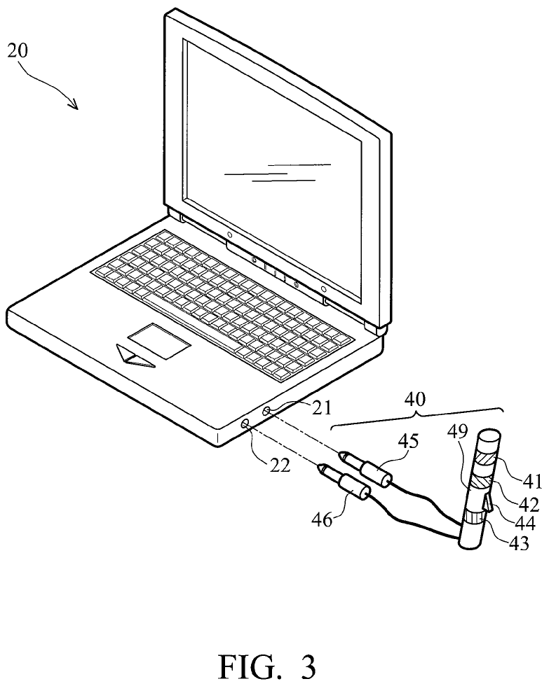

FIG. 3 depicts a microphone module 40 externally connected to a notebook computer 20 in accordance with a second embodiment of the invention. The microphone module 40 includes a microphone array 41, a digital signal processor (DSP) 42, a battery 43, a switch 44, a first connecting part 45, a second connecting part 46, and a housing 49, described as follows.

In the second embodiment, the housing 49 is oriented lengthwise. The microphone array 41, the digital signal processor (DSP) 42, and the battery 43 are disposed in the housing 49. The switch 44 is mounted on the housing 49. The first and second connecting parts 45 and 46 are provided outside the housing 49 for insertion into the first sound input jack 21 and the first sound output jack 22.

The microphone array 41 is uni-directional for receiving sound from a predetermined direction and correspondingly generating a first electrical signal. In the second embodiment, an omni-directional microphone and a uni-directional constitute the microphone array 41.

The digital signal processor (DSP) 42 receives the first electrical signal from the microphone array 41, receives the third electrical signal (far-end signal) from the notebook computer 20 through the second connecting part 46, executes beam-forming, noise suppression and echo cancellation, and obtains a second electrical signal (near-end signal). The second electrical signal is transmitted to the notebook computer 20 through the first connecting part 45 for sound-recording, internet communications or other operation.

The battery 43 is disposed in the microphone module 40 for supplying power to the digital signal processor (DSP) 42. The battery 43, however, can be replaced with a universal serial bus (USB) connector.

As described, the microphone array 31 receives sound from a predetermined direction. However, in some situations (e.g. in a meeting) sound from all directions is to be received. Thus, the uni-directional microphone of the microphone array is turned off by the switch 44 and only the omni-directional microphone of the microphone array operates. Under such a circumstance, the digital signal processor (DSP) 42 performs noise suppression and echo cancellation. The operation of beam-forming is not required and is thus omitted.

In the second embodiment, the microphone array 41 includes an omni-directional microphone and a uni-directional microphone. The microphone array, however, may include two omni-directional microphones or two uni-directional microphones. When two omni-directional microphones constitute the microphone array and sound from all directions is to be received, one of the omni-directional microphones is turned off by the switch and the other is used to receive sound. When two unidirectional microphones constitute the microphone array, there is no way to receive sound from all directions by turning off any of the uni-directional microphones. Thus, no switch is provided.

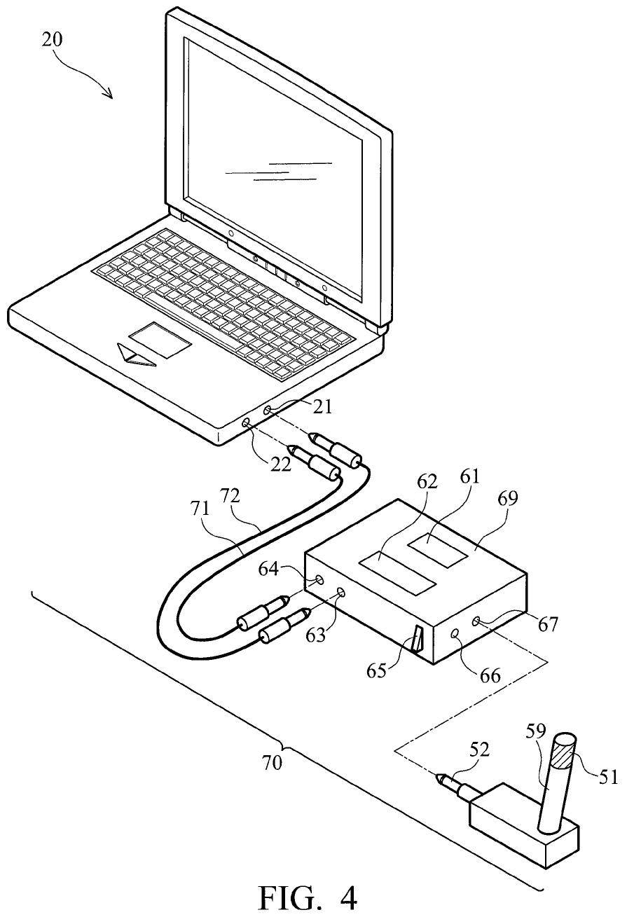

FIG. 4 depicts a microphone module 70 externally connected to a notebook computer 20 in accordance with a third embodiment of the invention. The microphone module 70 includes a housing 59, a microphone array 51, a box 69, a digital signal processor (DSP) 61, a battery 62, a switch 65, a first connecting part 71, a second connecting part 72, and a third connecting part 52, described as follows.

The housing 59 is substantially L-shaped. The microphone array 51 is disposed in the housing 59. The third connecting part 52 protrudes from the housing 59.

The digital signal processor (DSP) 61 and the battery 62 are disposed in the box 69. The switch 65 is mounted on the box 69. The box 69 has a second sound input jack 67, a second sound output jack 66, a third sound output jack 64, and a third sound input jack 63. The first connecting part 71 connects the first sound input jack 21 and the third sound output jack 64. The second connecting part 72 connects the first sound output jack 22 and the third sound output jack 63. The third connecting part 52 can be inserted into the second sound input jack 67. Thus, the notebook computer 20 outputs the sound signal via the second sound output jack 66 instead of the first sound output jack 22.

The microphone array 51 is uni-directional for receiving sound from a predetermined direction and correspondingly generating a first electrical signal. In the third embodiment, an omni-directional microphone and a uni-directional constitute the microphone array 51.

The digital signal processor (DSP) 61 receives the first electrical signal from the microphone array 51 through the third connecting part 52, receives the third electrical signal (far-end signal) from the notebook computer 20 through the second connecting part 72, executes beam-forming, noise suppression and echo cancellation, and obtains a second electrical signal (near-end signal). The second electrical signal is transmitted to the notebook computer 20 through the first connecting part 71 for sound-recording, internet communications or other operation.

The battery 62 supplies power to the digital signal processor (DSP) 61. The battery 62, however, can be replaced with a universal serial bus (USB) connector (not shown).

As described, the microphone array 51 receives sound from a predetermined direction. However, in some situations (e.g. in a meeting) sound from all directions is to be received. Thus, the uni-directional microphone of the microphone array is turned off by the switch 65 and only the omni-directional microphone of the microphone array operates. Under such a circumstance, the digital signal processor (DSP) 61 performs noise suppression and echo cancellation. The operation of beam-forming is not required and is thus omitted.

In the third embodiment, the microphone array 51 includes an omni-directional microphone and a uni-directional microphone. The microphone array, however, may include two omni-directional microphones or two uni-directional microphones. When two omni-directional microphones constitute the microphone array and sound from all directions is to be received, one of the omni-directional microphones is turned off by the switch and the other is used to receive sound. When two uni-directional microphones constitute the microphone array, there is no way to receive sound from all directions by turning off any of the uni-directional microphones. Thus, no switch is provided.

The invention provides an externally connected microphone module containing a microphone array. The quality of received sound is good. If necessary, the microphone module can receive sound merely by the omni-directional microphone therein. It is therefore understood that the invention is capable of satisfying user's requirements.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An assembly comprising:
an electronic device comprising a first sound input jack; and
a microphone module externally connected to the electronic device, comprising:
a microphone array receiving sound and generating a first electrical signal;
a digital signal processor receiving the first electrical signal, executing beam forming and noise suppression, and obtaining a second electrical signal; and
a first connecting part inserted into the first sound input jack, transmitting the second electrical signal to the electronic device.

2. The assembly as claimed in claim 1, wherein the microphone module further comprises a battery supplying power to the digital signal processor.

3. The assembly as claimed in claim 1, wherein the microphone module further comprises a universal serial bus connector supplying power to the digital signal processor.

4. The assembly as claimed in claim 1, wherein the microphone module further comprises a housing, the microphone array and the digital signal processor are disposed in the housing, and the first connecting part is disposed outside the housing.

5. The assembly as claimed in claim 1, wherein the electronic device further comprises a first sound output jack, and the microphone module further comprises a second connecting part inserted into the first sound output jack, transmitting a third electrical signal from the electronic device to the digital signal processor for performing echo cancellation.

6. The assembly as claimed in claim 5, wherein the microphone module further comprises a housing, a third connecting part, and a box; the microphone array is disposed in the housing; the third connecting part protrudes from the housing and detachably connects to the box; and
the digital signal processor is disposed in the box and electronically connected to the electronic device via the first and second parts.

7. The assembly as claimed in claim 6, wherein the box comprises a second sound input jack and a second sound output jack, and the third connecting part is connected to the second sound input jack.

8. The assembly as claimed in claim 1, wherein the microphone array comprises a uni-directional microphone and an omni-directional microphone.

9. The assembly as claimed in claim 8, wherein the microphone module further comprises a switch turning the uni-directional microphone on or off.

10. The assembly as claimed in claim 1, wherein the microphone array comprises two omni-directional microphones.

11. The assembly as claimed in claim 10, wherein the microphone module further comprises a switch turning one of the omni-directional microphones on or off.

12. The assembly as claimed in claim 1, wherein the microphone array comprises two uni-directional microphones.

13. The assembly as claimed in claim 1, wherein the electronic device comprises a cellular phone, a personal digital assistant, or a global positioning system.
